(19) United States
(12) Patent Application Publication
(10) Pub. No.: US 2016/0321408 A1
(43) Pub. Date: Nov. 3, 2016

(54) SYSTEM AND METHOD FOR ASSESSING AND IMPROVING THE QUALITY OF CARE PROVIDED BY PHYSICIANS AND OTHER HEALTHCARE PROFESSIONALS IN THE WORKPLACE

(71) Applicant: LAWRENCE J. HARMON, MIAMI, FL (US)

(72) Inventor: LAWRENCE J. HARMON, MIAMI, FL (US)

(21) Appl. No.: 14/702,158

(22) Filed: May 1, 2015

(51) Int. Cl. G06F 19/00; G06Q 30/02

(52) U.S. Cl. CPC G06F 19/327; G06F 19/3418; G06F 19/3425; G06Q 30/0203; G06Q 30/0282

(57) ABSTRACT

The present invention provides for a system and method for assessing and improving the quality of care provided by healthcare professionals in the workplace. A database is instantiated with user information from a plurality of users. A rating scheme is then created from the database comprising a plurality of ratees and raters. The rating scheme may be validated by a validator, and then surveys are automatically transmitted to the raters. The completed surveys are received and a report is generated for each rate, which may be subject to further approval. The ratees are then emailed software modules and prompted with reminders to select development goals, participate in online training, obtain ongoing evaluations from leadership, and receive follow-up survey feedback on the extent to which the ratee has improved. The software modules are determined by the system based on the behaviorally anchored feedback received for each ratee.

### BACKGROUND OF THE INVENTION

1. Field of the Invention

This invention is directed to a system and method for assessing and improving quality of professionals in the workplace. More particularly, the present invention is directed to a system and method for interactive user input and data mining operations in order to provide an aggregate evaluation of a professional and to provide targeted training for that professional.

2. Description of the Related Art

In the field of human resources and industrial psychology, “360-degree feedback” or multisource feedback is feedback that comes from members of an employee's immediate work circle. This feedback may come from an employee's direct subordinates, peers, or supervisors, and may also include a self-evaluation. Feedback may additionally include external sources, such as customers or suppliers, and other interested parties. The 360-degree feedback, in contrast to direct feedback from only an employee's immediate superior, provides a more holistic assessment of an employee's quality and performance in the workplace. Accordingly, 360-degree feedback may help an employee improve his or her overall work quality and performance, because it helps to evaluate several different perspectives of that employee. 360-degree feedback is traditionally conducted in the form of surveys, and has risen in popularity recently. Today, many U.S. companies employ some type of 360-degree or multisource feedback.

Despite this growing trend, the effectiveness of current 360-degree feedback systems and methods remain a major concern. For instance, the number of raters used in each category, e.g. subordinate, peer, supervisor, may affect the reliability of the feedback. The length of time that a rater has known the ratee may affect the accuracy of the evaluation. Other factors such as how the raters or ratees are selected, potential abuse in the approval process, participation rate, the presentation of information, training and coaching, and accountability may all affect how well a 360-degree feedback system might perform. Accordingly, there is a need for a set of tested and well-defined criteria for 360-degree feedback systems and methods that can accurately and consistently assess quality within a profession. There is also a need to present this assessment in an easily interpretable manner that effectively pinpoints particular weaknesses of an employee, as well as for the targeted training related to those weaknesses.

### SUMMARY OF THE INVENTION

The present invention is generally directed to a system and method for assessing and improving quality of professionals in the workplace. As such, the present invention helps a professional gain a better awareness of how he or she is perceived by others in the work place. Accordingly, the present invention involves using perceptual data, including anonymous workplace feedback, to help a professional improve various teamwork, leadership, or professional skills.

In initially broad terms, a method of the present invention may comprise first instantiating a database with user information of each of a plurality of users. Accordingly, in at least one embodiment, the users share a common workplace, or are otherwise linked by a common employer or department. The user information may include user names, titles, department, contact information, length of employment, among other relevant information.

Next, a rating scheme is created for the plurality of users, comprising a plurality of ratees and raters, wherein each ratee is to be reviewed by at least one rater. In various embodiments, ratees may be able to select their raters. In other embodiments, raters may be able to select their ratees. In yet other embodiments, a user may be able to select both ratees and raters. Users may be asked to select ratees and/or raters that they work with the most. Ratees and/or raters for a user may also be recommended to the user based on user information.

The rating scheme may then be validated by at least one validator. The validator may approve, for a user, ratees or raters selected by that user. The validator may additionally be able to remove or add additionally ratees and/or raters confidentially. Multiple validation steps by a plurality of validators may be used to ensure that a single validator does not abuse his or her position to purposefully create a good or bad rating for a certain user.

After validation of the rating scheme, surveys are transmitted to each of the plurality of raters of each ratee. The survey may include information related to the ratee the rater is rating. In at least one embodiment, the survey allows a rater to provide certain behaviorally-anchored feedback about a ratee. Behaviorally-anchored feedback may comprise a list of motivating behaviors. Behaviorally-anchored feedback may also comprise a list of discouraging behaviors. These behaviors may be ranked on a numerical scale. The survey may also provide for comment sections.

After the surveys are completed, they are received for data processing. Completed surveys may be checked for accuracy and completion. Incomplete surveys may be flagged or retransmitted back to a rater for completion. In other embodiments, a rater may be unable to return a complete survey until required fields of the survey are completed.

A report is then generated for each ratee based on data mining operations of the received and completed surveys. The report may display numerical values of behaviors ranked by the raters as well as graphical representations thereof. The display may categorize the raters into groups such as peers, subordinates, or superiors. The report generation step may also perform anonymity editing operations, which may comprise processes or operations designed to de-identify raters. The report generation step may also identify and cluster word-themes by performing data mining operations on the completed surveys from a ratee's raters. The report generation may also flag inappropriate comments or automatically indicate that the inappropriate comment has been deleted.

The generated reports may then be approved by at least one validator, which may involve the redaction, editing of the generated reports. For instance, a validator may be able to redact flagged inappropriate comments from the report generation step. Validation by multiple validators may also be used to ensure accuracy and to prevent abuse by any one validator. A revision history logging edits by a validator may also be included during this step.

After, the approved reports are transmitted to the ratees. As such, each ratee will receive his or her own respective report. The transmission may be in the form of a physical report, as an email, or as electronic data stored, hosted, and accessible by a ratee.

Additionally, a debriefing step may follow the transmission of the report, which involves identifying strengths and weaknesses of a ratee with a development coach. The ratee may also set development goals. The development coach may comprise at least a partially automated or computerized process, such as an interactive web platform or application. The development coach may also comprise real person interaction via a web platform, by email, phone, web conference, or other communications methods. A report of the goals may be transmitted to the ratee, as well as a validator, during this step.

Training module(s) may then be offered to each ratee, based on the results of the software automatically analyzing the ratee's numerical scores from the plurality of raters and/or the frequency of certain word-themes and/or based on the identified development goals of the ratee. The training module(s) may comprise particular lessons in text and/or video format custom tailored for the ratee, based on the ratee's practice style, professionalism, and interpersonal and communication strengths and weaknesses. As such, the ratee or professional is able to increase his or her overall awareness and thereby improve upon any weaknesses.

Follow-up surveys may be transmitted after the training period, or after the completion of the training module(s) of a ratee. In at least one embodiment, follow-up surveys may be transmitted to each ratee's plurality of raters. The follow-up surveys may be substantially similar to the initial survey that was transmitted to each ratee's raters during the survey transmission step above. The follow-up survey may comprise additional questions relating to the ratee's behavior during and throughout the training period.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1A is a flowchart illustrating a method for assessing and improving quality of professionals within the workplace in accordance with one embodiment of the present invention.

FIG. 1B is a flowchart illustrating a method for assessing and improving quality of professionals within the workplace in accordance with another embodiment of the present invention.

FIG. 2 is a block diagram of one embodiment of a processing configuration used in the system of the present invention.

FIG. 3 is a block diagram of one embodiment of the present invention incorporated into a network system for remote access. Like reference numerals refer to like parts throughout the several views of the drawings.

### DETAILED DESCRIPTION OF THE PREFERRED EMBODIMENT

As schematically represented in the accompanying drawings, the present invention is generally directed to a system and method for assessing and improving the quality of care provided by physicians and other healthcare professionals in the workplace. The physicians and other healthcare professionals may include but are not limited to those in the medical, hospital, clinic, healthcare, malpractice, quality improvement and related businesses, and the like. In at least one embodiment, a professional may be able to compare his or her self-perception of various workplace behaviors and skills against how others perceive the professional. The objective is to provide feedback that may enable the professional to feel confident and appreciated for his or her contributions, become more aware of his or her overall workplace patterns, and hopefully improve upon his or her strengths and/or remedy any weaknesses.

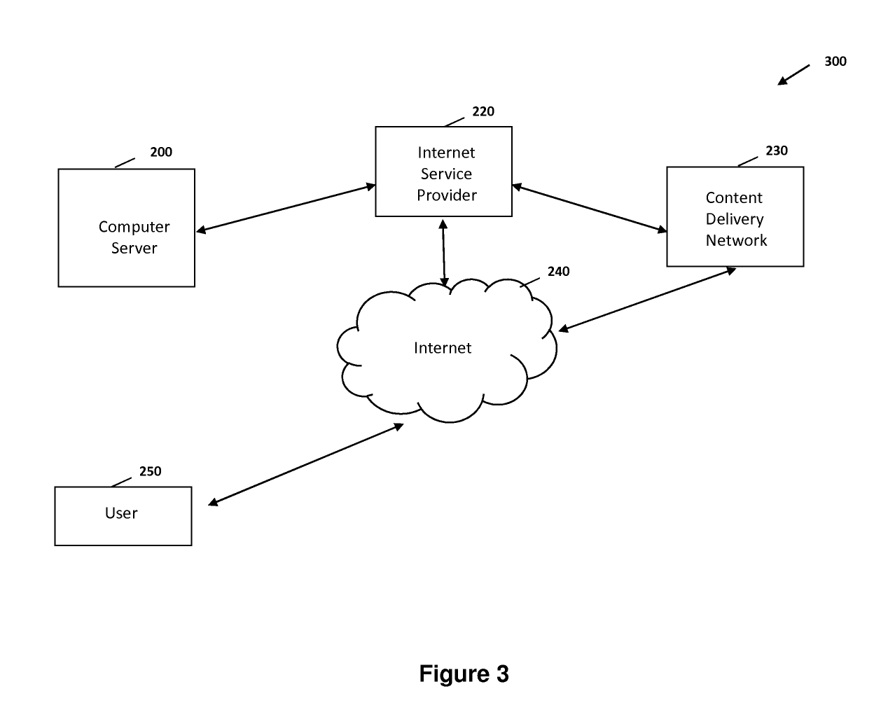

As illustrated in FIG. 3, the system 300 of the present invention may comprise a processing device or computer or computer server 200 in communications with a user 250. In at least one embodiment, the user 250 may access the computer 200 through the Internet 240 via at least one Internet service provider 220, and optionally via a content delivery network 230 which may comprise other computers or servers.

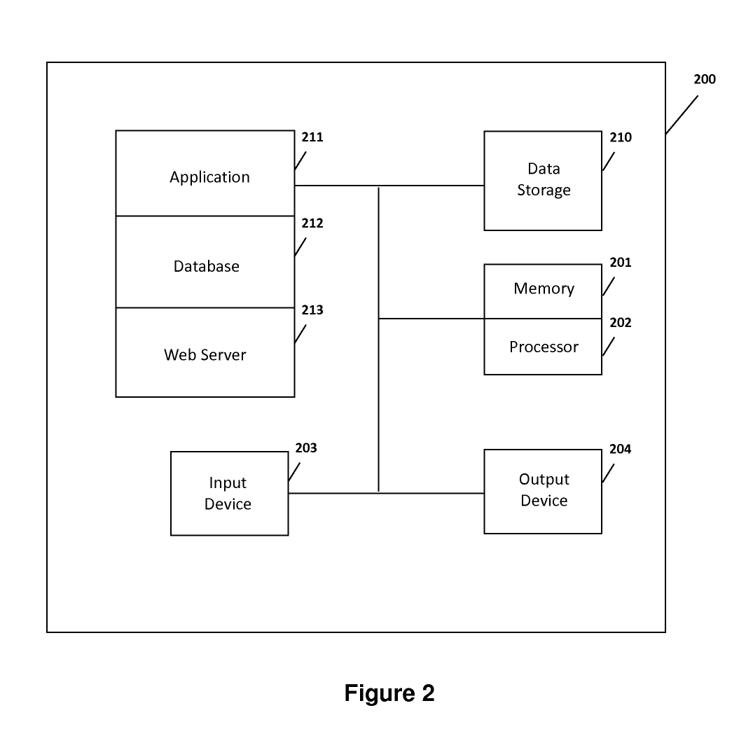

As such, and according to the schematic illustrated in FIG. 2, the processing device or computer 200 may comprise memory 201 and processor 202, data storage 210, application 211, database 212, web server 213, an input device 203 and an output device 204. The memory 201 may include random access memory (RAM) or similar types of writeable memory, and may store one or more applications 211 configured to receive, store, and process information relating to assessing and improving quality of physicians and other healthcare professionals in the workplace, for execution by processor 202. Data storage 210 may include hard disks, floppy disks, CDs, DVDs, or other types of non-volatile data storage. The local cache, database, or data store, application, web server applications, or other data or software, for assessing and improving the quality of care provided by physicians and other healthcare professionals in the workplace, may be stored on the data storage 210. Data storage 210 may comprise multiple components stored on different computers or servers, for redundancy, security, or other reasons. Input device 203 may comprise keyboard, mouse, cursor-control, touch-screen, infrared, microphone, digital camera, video recorder, motion or gyroscopic control, or any other device or input method appropriate for receiving, storing, and processing information related to assessing and improving the quality of care provided by physicians and other healthcare professionals in the workplace. Output device 204 may comprise any device capable and appropriate for presenting information, including but not limited to display devices, audio output devices, printers, or devices capable of transmitting information such as networking card, wireless transmitters.

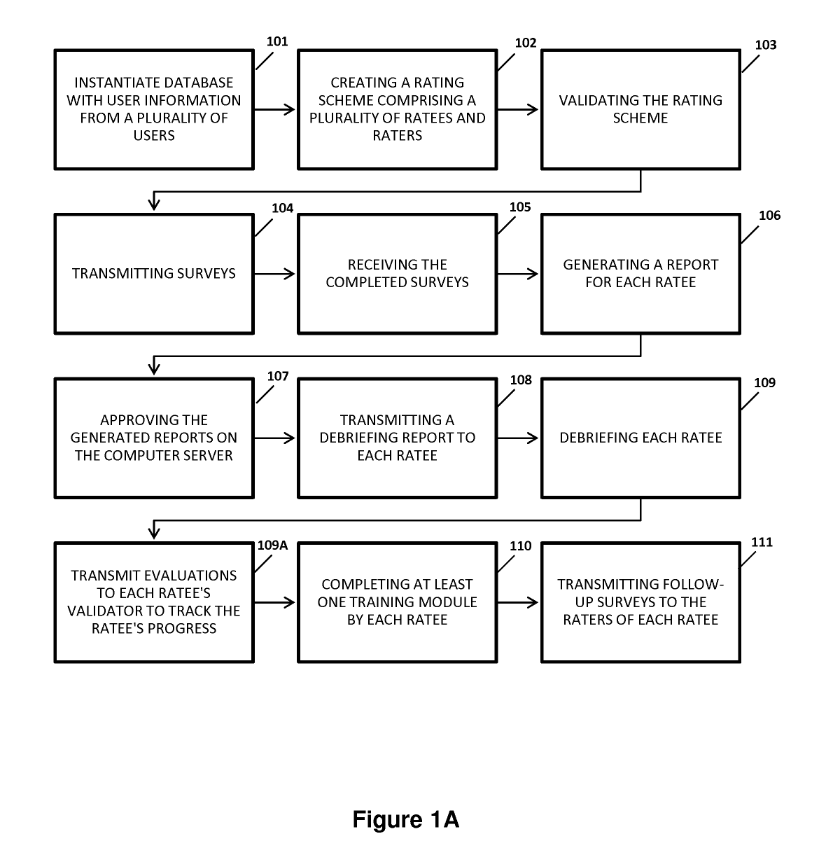

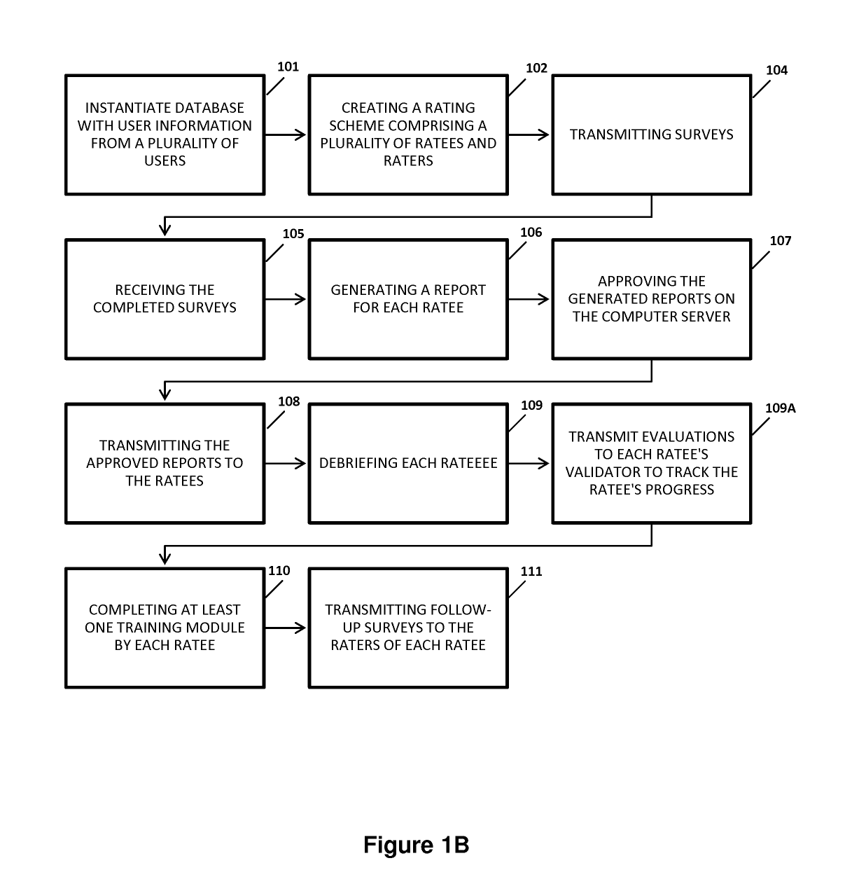

Application 211 include web enabling components, graphic user interfaces, input and output components, components required to process and execute the steps of the method of FIG. 1 below, and the like. Applications can further provide other functions, including but not limited to production, accounting, billing, order tracking, sales and marketing, and the like. Database 212 may serve as a data store for storing user information, the relationships between users, metadata, and the like. Web server 213 may provide access to applications and databases, or other information stored in memory 201 or data storage 210 to users through one or more communication networks such as the Internet. Web server may allow access to a user running a web browser, co-browser, or mobile application capable of retrieving content from a network and displaying information. Examples of the processing device or computer 200 may comprise personal computers, laptop computers, tablets, mobile phones, wearable electronic devices, Internet appliances, or any processing device capable of storing data and executing software or applications.

In an application server embodiment, the computer or computer server 200 may comprise appropriate hardware such as memory and at least a processor, operating system(s), software, databases, server applications, web-based applications, user interfaces or experiences (UI/UX) for performing the functionalities set forth in this application, as known to one skilled in the art. For example, the application server 105 may comprise LAMP, LYME, GLASS, LEAP, WISA, or any other solution stacks, web application frameworks, or other content management systems, and other front end and back end applications, scripts, and/or code as known to those skilled in the art.

In at least one embodiment of the present invention, the system 300 of the present invention may comprise at least one computer 200 in communication with a computer-readable medium or data storage 210 having instructions stored there on, which when executed, cause the computer to perform operations including variations of the steps detailed below and included in the method of FIG. 1. Accordingly, the system 300 may comprise a setup component, an enrollment or registration component, a rater selection component, validation component, a rating component, a survey instruction and transmission component, a survey reception component, a report generation component, a report approval component, a report transmission component, a debriefing and goal-setting component, a goal-reminder component, a training module component, a follow-up component. These components correspond to the method steps in FIG. 1 as detailed below. Similarly, each step of the method in FIG. 1 as detailed below may also be in the form of a code segment directed to at least one embodiment of the present invention, which is stored on a non-transitory computer readable medium, for execution by a computer for assessing and improving quality of care provided by physicians and other healthcare professionals within the workplace.

FIG. 1 depicts a flow chart of one embodiment directed to a method for assessing and improving the professionalism, teamwork, leadership, and quality of care provided by physicians and other healthcare professionals within the workplace. Accordingly, the method includes the steps of: instantiating a database with user information 101; creating a rating scheme 102; validating the rating scheme 103; transmitting surveys 104; receiving the completed surveys 105; generating a report for each ratee 106; approving the generated reports 107; transmitting the approved reports to the ratees 108; debriefing each ratee by using software which enables the selection of development goals and reminders in collaboration with a development coach or the ratee's leader, or on his/her own 109; transmitting evaluations to each ratee's validator or supervisor to track the ratee's progress 109A; completing when indicated by the software at least one training module by each ratee 110; and transmitting follow-up surveys to the raters of each ratee 111.

Step 101 for instantiating a database with user information includes inputting information of each of a plurality of users. The step may additional include initially setting up of a database structure. The database may be stored and accessible on at least one computer locally, or remotely, such as on a computer server or cloud server. In at least one embodiment, the users share a common workplace or are otherwise linked by a common employer, department, specialty, hospital, and/or healthcare system. The plurality of users may also include healthcare professionals, colleagues, team members, support staff, clients, patients, customers, suppliers, or other interested parties related to the system, department, specialty, employer, or workplace. Accordingly, each workplace, employer, specialty, system, or department may instantiate its own database in order to participate in the quality assessment and improvement program. In one embodiment, a facility liaison or a team of facility administrators may input the user information into a database. In other embodiments, each user may register and/or input his or her information, which may then be augmented and subject to further approval by an administrator. In at least one embodiment, the plurality of users instantiated in the database in step 101 comprises at least one validator who may augment and approve the final list of ratees. In other embodiments, where no validator is required, one user (rater) may select other users (ratees) and the software system will provide one survey for the rater to complete for each ratee. Each rater may be asked to select between a minimum and maximum number of ratees from several specific groups, e.g., physicians and nurses.

User information relating to the plurality of users may include identity information, demographic information, professional information, relational information to other users, as well as other relevant or appropriate information. Identity information may include a user's name including first and last, job title, specialty, department, contact information. For example, exemplary titles in the medical profession may include whether a user is a physician, nurse, a registered nurse, a physician's assistant, an intern, a resident or other positions. Exemplary departments and/or specialties may include anesthesiology, audiology, cancer services, dentistry, emergency medicine, family medicine, medicine, neurology, neurosurgery, obstetrics and gynecology, ophthalmology, orthopaedic surgery, pathology, pediatrics, pharmaceutical, psychiatry, radiation oncology, radiology, rehabilitation services, surgery, urology. Demographic information may include age, gender, race and ethnicity. Professional information may include degrees, board certification status or other certifications, history and experience. Relational information to other users may include length of time a first user has worked with a second user, the professional relationship, e.g., peer, mentor, validator, facility liaison, list liaison, observer, supervisor, employee or employer.

The aforementioned user information are exemplary information. Those skilled in the art can appreciate that various informational fields can be used to instantiate a database to facilitate the review or assessment of physicians and other healthcare professionals in the workplace. Those skilled in the art can also appreciate that certain user information may change over time to ensure that provide for adequate professional assessment.

The input of such information may be presented as an electronic form or as part of a graphic user interface (“GUI”). A user may input such information from a computer connected to the database via a communications network such as the Internet. Alternatively, a user may input such information at the server or computer comprising the database. Various fields may be set to as required fields that must be inputted for the registration or enrollment of a user, whereas other fields may be set to as optional fields. A comparison may be conducted manually or via computer operations to ensure that duplicate users are eliminated, and that user fields are accurate.

Step 102 for creating a rating scheme comprising a plurality of ratees and raters involve selecting raters and/or ratees based on the plurality of users instantiated in the database. Accordingly, this step involves the designation of users as ratees and raters, such that each designated ratee is to be rated, ranked, or reviewed by at least one rater.

In one embodiment of the present invention, ratees may be able to select their raters. Accordingly, at least one user is designated as a ratee. Next, at least one rater is designated for each ratee, wherein the rater is selected by the ratee from the plurality of users. The selection process may occur during the instantiation step as in step 101, wherein each user may register and/or input certain information into the database. Alternatively, the user may be able to access the database at a later time to select his or her raters. In certain embodiments, each user in the database may be designated as a ratee or rater by default. The validator, facility liaison and/or administrator may be omitted from the rater or ratee selection scheme, i.e. “rating scheme”. In at least one embodiment, the rater may manually add his or her own raters. A minimum and/or maximum number of raters per ratee may also be set. However, one potential pitfall of this schema might be that ratees will only select raters who might rate them favorably, thus creating a biased and/or inaccurate result for various ratees.

Therefore, in another and preferred embodiment of the present invention, raters may be able to select the ratees freely and/or subject to various criteria. The goal of schema is to ensure a more accurate review of each ratee, by placing the selection choice and power into the hands of the raters. Accordingly, at least one user is designated as a rater, or more preferably, each user in the system is designated as a rater. Next, at least one ratee is designated for each rater, wherein the ratee is selected by the rater from the plurality of users. In at least one embodiment, the rater selects from one category of users who, for example, are physicians, and from another category of users who for, for example, are nurses. The selection process may occur during the instantiation step as in step 101, wherein each user may register and/or input certain information into the database. Alternatively, the user may be able to access the database at a later time to select his or her ratees. In certain embodiments, each user in the database may be designated as a rater by default. The validator, facility liaison and/or administrator may be omitted from the rating scheme in such an embodiment.

The computer server 200 and accompanying software and database may mandate selection requirements, such requiring a minimum and/or maximum number of ratees per rater, based on category and/or based on the perception of the rater. For example, in one embodiment each rater may be required to select at least X number of ratees from the category of physicians, and at least Y number of ratees from the category of nurses. The goal of this is to provide a two-way feedback, or team-based feedback across hierarchical barriers.

In other words, by setting forth such a requirement in the rating scheme, evaluations of each ratee will not simply be limited to one's peers, but across an entire organization. In another embodiment, each rater may be required to select X number of “top performers”, Y number of “normal performers”, and Z number of “rough edges” or “poor performers”. This requirement built into the rating scheme helps to ensure a broader and more accurate sample of evaluations. This is also advantageous because it allows the hospital or organization to focus on their top performers and poor performers or rough edges, for example, in the determination of who to give a bonus or other recognition, or who could benefit from various training modules. In a preferred embodiment, these rating scheme minimums, maximums, or “selection criteria” for the raters may be adjustable through the computer server 200 and accompanying database, software, and user interfaces.

In another embodiment of the present invention, users may be able to select both ratees and raters. For instance, a user may be required to select a predetermined number of raters to rate the user, as well as a predetermined number of ratees the user will rate in a subsequent survey. Minimums and/or maximums of ratees or raters, along with how many times each rater has previously completed surveys, may be configured in the database, as well as the graphic user interface, e.g. a series of forms or windows, for input of such information. In one embodiment, ratees are guided to avoid raters who have been selected too often during the prior months and, instead, to select raters who have completed relatively fewer surveys in order to spread the responsibility of completing surveys across as many raters as possible.

In at least one embodiment, users will be asked to select ratees and/or raters that they work with the most. Users may be able to pick and click other users from a list of potential raters and/or ratees. Users may be able to search for users, or to filter categories of users, e.g. by department, work unit, specialty, title, last name, first name, or a combination thereof. The system of the present invention may suggest users by certain user information. Accordingly, in at least one embodiment of the present invention, users can only select ratees and/or raters within a direct feedback group, which may be comprised mostly of individuals who have either frequent or occasional high intensity contact with the user or professional during work. In a medical context this can include physician colleagues, nurses, technicians, and hospital or office staff. In at least one embodiment, an indirect feedback group may also be selected, and the indirect feedback group may be comprised mostly of individuals who are acquainted with the professional by way of others, but may not work with the professional on a daily basis. In a medical context this can include hospital administration, unit supervisors, department chiefs or chairs, medical executive committee members, medical directors, or other physicians.

Step 103 for validation of the rating scheme by at least one validator involves approving and/or adding ratees and/or raters selected by the users. Accordingly, in one embodiment of the present invention, a validator may approve, for at least one ratee, at least one rater selected by the ratee from the plurality of users. In at least one embodiment, a validator may approve, for at least one rater, at least one ratee selected by the rater from the plurality of users. Similarly, a validator may approve, for at least one user, at least one ratee or rater selected by the at least one user. In some embodiments, the validator may also be able to add and/or remove additional ratees or raters for each user. Accordingly, in various embodiments of the present invention, the validator may be able to ensure that the ratees and/or raters selected by each user are actually people that the user works closely with. The validator, for example, may comprise a department or unit supervisor, a senior executive, human resources personnel, a department chief or chair, a facility liaison, or other appropriate person or persons for the validation of a rating scheme. In at least one embodiment, the validation step may be confidential, wherein the ratee or rater has knowledge of the validation step, but is not informed by the software if any users have been added or dropped and/or what users the validator adds or drops for the user. Multiple validation steps may be performed by a plurality of validators to ensure that a single validator does not abuse his or her position to purposefully cause a good or bad rating for a certain user.

In certain embodiments, the validator may be able to add or designate raters and/or ratees for a user based on user information. The system of the present invention may suggest this information, for instance, through a graphical user interface. The system may also automatically designate or add raters and/or ratees for a user based on user information. For example, in at least one embodiment of the present invention, the system may use employment time and departments as parameters in designating ratees and raters. Accordingly, other users that have worked with a first user in the same department for a period of time between X and Y months may be designated as ratees and/or raters of the first user.

Such a parameter setting may increase the accuracy of the rating of the first user, because the length of time may be set so that other users only review a first user they have known long enough to get past the first impression, but do not know the first user long enough that they begin to generalize the first user favorably. In at least one embodiment, a preferred period of 12 months to 36 months may be used. In other embodiments, a period of 12 months to 24 months, or a period of 12 months to 36 months may be used. Those skilled in the art can also appreciate that other time periods, as well as other parameters or combination of parameters may be used to ensure accuracy of a review or assessment of a user.

Step 104 for transmitting the surveys involves transmitting a survey to each of the plurality of raters of each ratee. Each survey sent to each rater may include information related the ratee that the rater is rating, including identification information. The survey may include other appropriate information, such as instructions. The survey may allow a rater to provide certain behaviorally-anchored feedback about a ratee. Accordingly, the survey may provide for feedback regarding predetermined motivating behaviors, discouraging behaviors, insight or self-awareness, communication style, leadership style, teamwork behaviors, clinical style patterns related to patient satisfaction and/or quality of care, and/or other domains. In some embodiments, the survey questions may be organized in a way that correspond to the hospital's or specialty's codes of conduct, code of excellence,/or credentialing requirements, and/or performance or professionalism incentives.

In one embodiment of the present invention, motivating behaviors may comprise:
1. Flexibly Adapts—adapts to change; open to suggestions
2. Manages Stress—focused and approachable under stress
3. Trustworthiness—straightforward; admits when wrong
4. Interacts Respectfully—treats others respectfully, expresses requests clearly, points out mistakes respectfully
5. Gives Information—keeps others informed; gives clear requests and explanations
6. Skillfully Communicates—expresses opinions; listens to others
7. Manages Conflict—tries to solve conflicts; handles difficult people well
8. Encourages Others—gives recognition or praise
9. Helps Out—helps out when necessary
10. Manages Time—shows up and gets things done on time
11. Decides Effectively—analyzes before deciding; makes good decisions
12. Solves Problems—identifies, solves important problems
   One or more of the above behaviors may be used in a survey in various orders. Each of these behaviors may be rated by the rater on a numerical level, such as from 1 to 5 or from 1 to 10, with 1 being the lowest and 5 or 10 being the highest. Each of the behavior categories may further comprise subcategories or more specific descriptions, which may be rated separately, e.g. “1. Flexibly Adapts” may further include “a. Is open to suggestions” and “b. Adapts to—and compiles with—changing policies, procedures, and priorities.” Alternatively, only each subcategory of a category is rated separately, and the category score represents an average of the scores of all the subcategories. In at least one embodiment, a higher score for motivating behaviors of the scale would be preferred. However, as one skilled in the art can appreciate, other numerical ranges or rating methods may be used.

In one embodiment of the present invention, discouraging behaviors may comprise:
1. Passive Aggressive—criticizes indirectly; keeps only favorites informed
2. Responsibility Resistant—avoids responsibilities; responds late to calls or requests
3. Negativity—unfairly badmouths others
4. Arrogance—arrogantly demands things; talks down to others
5. Poor Anger Management—snaps at others; angry or sarcastic to others; offensive gestures
6. Defensiveness—overreacts; defensive; blames others
7. Perfectionistic Overreaction—overreacts, insults or screams over minor problems
8. Severe Verbal Anger—yells, swears, or indicates retaliation
9. Embarrasses Others—intentionally embarrasses others publicly
10. Sexual Harassment—makes inappropriate sexual comments or gestures
11. Discriminatory Behavior—makes prejudiced comments or acts discriminatory
12. Physical Anger—bangs or throws things when angry or frustrated
   Similar to the motivating behaviors, one or more of the above discouraging behaviors may be also be used in a survey in various orders. Each of these behaviors may be rated by the rater on a numerical level, such as from 1 to 5 or from 1 to 10, with 1 being the lowest and 5 or 10 being the highest. Each of the behavior categories may further comprise subcategories or more specific descriptions, which may be rated separately, e.g. “1. Passive Aggressive” may further include “a. Criticizes certain team members, behind their back” and “b. Selectively informs only favorites of important information.” Alternatively, only each subcategory of a category is rated separately, and the category score represents an average of the scores of all the subcategories.

In at least one embodiment, a lower score for discouraging behaviors of the scale would be preferred. However, as one skilled in the art can appreciate, other numerical ranges or rating methods may be used. It should be understood that motivating behaviors may include any other behaviors or identifiers that indicates motivation or encouragement to staff, team members, coworkers, and others a professional works with, to do their best work. Similarly, discouraging behaviors may include any other behaviors or identifiers that indicate disruption or discouragement to others from doing their best work while around the professional. In some embodiments of the survey, other behaviors may be added as they relate to various domains identified by the client. In other embodiments of the survey, the behaviors are associated with behaviors important to the practice of a particular occupation, such as a medical specialty.

The survey transmitted to a rater may further comprise fields for free-style comments about a ratee. These fields may be titled accordingly, such as behavior the rater would like the ratee to start doing, to stop doing, and/or to keep doing. The fields may be general, and may allow a rater to provide any additional feedback for the ratee, whether it's positive, negative, or neutral. The step 104 may optionally involve the transmission of a survey or self-survey to each ratee. In at least one embodiment, the self-survey transmitted to the ratee is substantially the same as the survey sent to each of the plurality of raters of each ratee. Accordingly, the survey sent to the ratee or the self-survey may allow a ratee to compare how he or she perceives him or herself, compared to the perception of others. The system of the present invention may optionally send or transmit reminders at predetermined intervals to each of the raters for each of the surveys, as well as the ratee for a self-survey, until a completed survey is received back by the system or the deadline date has been reached, whichever comes first.

Step 105 for receiving the completed surveys involves receiving the completed surveys back from each of the plurality of raters, for each ratee. In some embodiments, the system may check for completion of the survey, and if a survey is incomplete the system may return an error message to the rater and request the completion of the survey. In some embodiments, a user who is a rater may be able to complete a survey online such as through a website or mobile application. In these embodiments, a user may be able to save a partially completed survey. A user may be able to submit a survey upon completion, and the system or a server and applications thereon may check for accuracy and completion. If a survey is incomplete, the system may return an error message to the user, and may further highlight or direct the user to fields or parts of the survey that requires further attention.

Step 106 for generating a report for each ratee involves data mining operations of the received and completed surveys, and the presentation of various data collated from the surveys. In at least one embodiment, the reports may be generated after a predetermined time after the surveys are transmitted, as in step 104. In other embodiments, the validator or an administrator may select when to generate the reports. In one embodiment, the report for each ratee may be generated as all surveys for that ratee are completed by respective raters. In other embodiments, the reports for all the ratees may be generated upon the receipt of the last completed survey.

In at least one embodiment of the present invention, each report generated for a ratee may comprise aggregate results of how the ratee was rated by a plurality of raters. Accordingly, at least one section of the report will present to the ratee a list of behaviorally-anchored feedback. In at least one embodiment, the behaviorally-anchored feedback comprises a list of predetermined motivating behaviors or discouraging behaviors such as the list discussed above in step 104. Similarly, the behaviorally-anchored feedback may further comprise a list of other predetermined behaviors and/or domains also presented above. As such, the rating of such categories and subcategories may comprise scores ranging from a predetermined scale of 1 to 5 or 1 to 10 or other appropriate scoring ranges. The report may present the mean, average, mode, percentile or other statistical representation of the numerical data for at least one category. This statistical representation may further be presented based on the user information, such as categories or job titles of the raters. For instance, in a medical setting, a ratee may be presented with the average scores given to him or her by physicians compared to nurses and other healthcare staff. Similarly, a ratee may be presented with various statistical data or indicators grouped by peers, supervisors, subordinates.

One section of the generated report for a ratee may include the top behaviorally-anchored behaviors their associated sub-categories. These categories may be listed in ascending or descending order. For instance, the top 5 motivating behaviors and the top 5 discouraging behaviors may be generated on the report. This allows a ratee to effectively set goals on what needs the most improvement, as well as an understanding of what the ratee does well and should continue to maintain. Another section of the generated report may comprise detailed scoring of each behavioral category and subcategories. The scoring may further be broken down into averages based on groups, i.e. peers, supervisors, subordinates, and also a self-rating. The system may be able to calculate scores that are above average and those that are below average. These scores may be presented in graphical form such as a line graph, a bar graph, a chart, or other graphical representations. These scores may be color-coded so a ratee can quickly identify which areas or behaviors may be very favorable or potentially problematic. For instance, a subordinate group may rate the ratee poorly in “Overreacts and defensive to suggestions” while a peer group may rate the ratee favorably. This allows a ratee to not only address a certain behavior, but also to improve that behavior with respect to interactions with a particular group in the workplace.

In at least one embodiment, the system performs data mining operations of the plurality of completed surveys to identify word-themes in order to present patterns or trends to the ratee. For example, the words “listen,” “listening,” and “listener” may count as one word-theme. Accordingly, each instance of a variation of the word “listen” may add to the occurrence of the word-theme. The most frequent word-themes may be presented first to the ratee in the ratee's report. These word-themes may further comprise favorable word-themes and unfavorable word-themes. In at least one embodiment, word-themes are presented to the ratee, categorized as behavior others would like the ratee to start, to stop, or to keep performing. These categories may be organized according to the particular fields of the surveys transmitted to the raters, as in step 104. For instance, in step 104 a rater may be prompted with a comment box asking the rater to comment on behaviors the rater would like the ratee to begin or to start performing, comments in this box will be presented to the ratee under a section with the heading “OTHERS would like you to START.” In other embodiments, these categories may be extrapolated based on the language of the feedback itself. In at least one embodiment, if a comment by a rater fits into more than one word theme, the comment may be displayed also in the second word theme area, and may further be annotated that it has already been generated earlier. Additionally, each section may also present the ratee with comments from the survey completed by the ratee, or the self-survey.

By way of example, a ratee may be presented with the following sections in a report:

YOU wrote that you would like to START:
Delegating more effectively.

OTHERS would like you to START:
1. Listening and taking to heart some opposing opinions.
2. Listening to my concerns patiently.
3. Listening to others opinions.
4. Listening to others' input more calmly.
5. Being as patient as you can be with the support staff when needing things in a hurry.
6. Being patient with staff.
7. [Listening to my concerns patiently.] (Copy of #2)

YOU wrote that you would like to STOP:
Working more than 12 hours a day, 6 days a week, and being exhausted.

OTHERS would like you to STOP:
1. Snapping at others sometimes when you are stressed; it can be intimidating.
2. Snapping at those around you; it discourages our work.
3. Choosing to snap at others in frustration.
4. Making some snap judgments.
5. Getting easily frustrated.
6. Being the type of person who frustrates easily.
7. [Choosing to snap at others in frustration.] (Copy of #3)

YOU wrote that you would like to KEEP:
Maintaining high quality work products.

OTHERS would like you to KEEP:
1. Being always punctual.
2. Being tremendously punctual with your schedule; thank you.
3. Having a great punctuality with regard to assignments.
4. Having a high quality work product.
5. Prioritizing quality.
   The above comments include a self-comment from the self-survey, and comments from others that may have come from a number of raters, wherein each of the raters filled in comments for the survey of the ratee. Accordingly, the word-themes are clustered or grouped together according behaviors the raters would like the ratee to begin, stop, or keep performing, then presented to the ratee. In the example embodiment, the word-theme language is in bold, and the most frequently commented on word-theme appears first to the ratee under each section, i.e. START, STOP, and KEEP. One or more of these sections may be used in the report. Number 7 under the START section is a copy of number 2, and accordingly, the system may annotate that comment with “Copy of #2.”

The word-themes may be predetermined in at least one embodiment of the present invention. For instance, the system may perform data mining operations and test the language of each of the surveys against a dictionary file, list, or database comprising a list of word-themes. Word-themes may vary by profession, profession, department, by the section of the survey, by language, or by any other distinguishing aspects. Accordingly, different dictionary files, lists, or databases of word-themes may be used depending on these and other factors.

In at least one embodiment of the present invention, the invention performs “reliability safeguard” protocols during the report generation step of step 106. These protocols are programmed into the report generation step using appropriate scripting and/or programming languages known to those skilled in the art. Specifically, one novel element of the reliability safeguard component is that it is configured to automatically hide scores from evaluations, if only a very limited number of raters have scored a ratee in a particular area. For example, a rules-based engine or programmable logic may first determine if rater number threshold is <X and, if so, then the reliability safeguard component may automatically replace the score with a notice “limited data” on the report.

Another novel aspect of the reliability safeguard component is the ability to merge several groups of raters into a single group, so that the aggregate scores will become more meaningful and the anonymity of the raters will be more likely to be preserved. For example, if a database schema of the computer server 200 comprises both “operating room nurses” and “floor nurses”, and a ratee's evaluation comprises “operating room nurses” <X and/or “floor nurses” <Y, then the reliability safeguard component may be configured to merge the “operating room nurses” and “floor nurses” into one grouping, displaying a new grouping called “operating room nurses +floor nurses” in the evaluation report and showing the aggregate scores from the combined two groups. Accordingly, the reliability safeguard component may be programmed with appropriate logic to automatically combine different groups of “physicians” or different groups of “nurses”, or “nurses” with “physicians” if no other similar groups exist in the database, when the number of raters in each different group is below a certain predefined threshold.

In at least one embodiment, the system may perform anonymity editing operations. Anonymity editing may comprise processes or operations designed to help de-identify raters. In one embodiment, the system may perform data mining operations to test language of the comments against dictionary files, lists, or databases comprising, for instance, standardizing the tense of initial verbs, re-arranging comments according to word-themes, standardizing comment punctuation, and/or identifying possibly inappropriate or obscene words or language. In the latter case, some inappropriate comments may be automatically redacted and/or displayed as inappropriate comments which have been deleted, or may be reviewed and flagged for removal by the validator or administrator during the approval step, as in step 107.

In at least one embodiment, the system creates a separate and more comprehensive narrative report comprised of more detailed and descriptive information, such as which group of raters provided the lowest or highest overall scores, which behaviors were scored in favorable or unfavorable ranges, how many behaviors were scored in favorable or unfavorable ranges, and/or a detailed set of recommendations comprising a customized improvement plan. The system performs data mining operations of the ratee's demographic information to automatically insert the name, address, and/or appropriate pronouns such as his or her when referring to the ratee's scores and recommendations. The system performs analyses on the ratee's scores on specific behaviors and then it selects specific recommendation sentences to insert into the comprehensive recommendations report. Based on the date the report is prepared, the system automatically inserts predetermined time intervals in the form of deadline dates by which each recommendation must be completed. When the ratee has had more than one survey, the system may perform data mining operations of the ratee's prior survey data and use the prior data to create subsequent follow-up comprehensive reports which display comparison information, for example, showing percentage improvement for each behaviors and performance trending graphs for each group of raters for each prior survey up to the most recent survey data.

The present invention may also leverage data collected nationally from a plurality of different hospitals across different specialties. As such, at least one report of the present invention may comprise benchmarked reports for each ratee as compared to other ratees. The benchmark report may be adjustable by filtering the overall data, such as benchmarking a ratee in accordance to his or her region, specialty, hospital or institution, occupational group, education level, as well as other known and tracked data fields as described above.

Step 107 for approving the generated reports by the validator or other designated personnel involves flagging as an inappropriate comment to be deleted comments that contain unusually specific identity information and/or inappropriate comments which have no constructive merit. In one embodiment, one or more inappropriate comments may be automatically redacted and/or designated as a deleted inappropriate comment by the software prior to submission to the validator, or may otherwise be set to redact upon the validator's review and request. The validator or other designated personnel may perform redacting operations on the inappropriate comment in at least one embodiment. Upon approval by the validator, a report may then be transmitted to the ratee and/or to the designated debriefer who will deliver the report to, and review the report with, the ratee.

Step 108 for transmitting the approved reports to the ratees and/or to the debriefer involves transmitting the final and approved reports to the plurality of ratees. Accordingly, each ratee will be encouraged to receive his or her own respective report, the report being an end product of data mining operations from the plurality of completed surveys for that ratee. The report may display the total number of raters and the comparison norms used to prepare the report, and may comprise an introduction or instructions of how to review the report. The report may also comprise one or more sections generated by step 106 above relating to the scoring and word-themes from the plurality of completed surveys. The transmission may be in the form of a physical report, in the form of an email, an electronic file or data hosted and accessible by a ratee, or other means of transmission appropriate for the access and review of a report.

Step 109 for debriefing each ratee may be conducted by the ratee himself or herself or by a designated debriefer, such as the respective validator, facility liaison, mentor or development coach. The debriefer helps the ratee in identifying strengths as well as potential improvement areas so that a ratee may be able to set development goals for any areas needing improvement. The designated receiving user or debriefer along with the ratee may use a partially automated module in the form of a web-based interactive platform which displays the ratee's comments from raters, and prompts the ratee to collaborate with the debriefer to select specific comments which would be appropriate development goals. The debriefing may also comprise real person interaction via the web platform, by email, phone, web conference, or by other methods of interaction.

In at least one embodiment, the debriefer and ratee may discuss the meaningfulness of raters' feedback, the costs and benefits of making changes based on the feedback, approaches to improve on certain identified behavior patterns, and/or strategies to achieve the goals the ratee has set for him or herself. For instance, a number of START, STOP, or KEEP goals may be discussed with the debriefer directed to behavior the ratee should start doing, stop doing, or continue to perform. These goals may further be targeted towards a particular group of raters, for instance, the debriefer may discuss with the ratee the benefits of stopping aggressive behavior towards subordinates or staff, or with a particular department, or other group, based on specific feedback from that group. The ratee is asked to click on the development goals that the ratee has created in the module, indicating that has selected these development goals. In at least one embodiment, the module also indicates that the development goals will be automatically transmitted for review and approval to the ratee's validator, supervisor, human resources personnel, other designated persons responsible for or associated with the ratee, and/or to the development coach who may transmit the development goals of a ratee in turn to the validator and/or other designated person. An accompanying debriefing report may be transmitted to the ratee as well as the debriefer from the computer server 200.

In a preferred embodiment, the ratee may be directed to an interface within the software, where common word-themes are highlighted and automatically linked to selectable training modules. For example, if the word-theme for “listen” was repeatedly data mined out of evaluations for a ratee, such that the number of occurrences exceed X, then the computer server 200 and appropriate software logic may automatically link the word “listen” to a training module, whether in text, interactive, or video format, to the ratee. In a preferred embodiment, multiple levels of training modules may be offered to a rate, such that a simpler level 1 “How to Listen Better” module may be offered to a ratee having an unfavorable “listen” word-theme occurrence of >X, while a more comprehensive level 2 “How to Listen Better” module might be offered to a ratee having an unfavorable “listen” word theme occurrence of >Y.

Step 109A is directed to automatically prompting the ratee and his/her validator or designated monitor to complete evaluations of the ratee's progress towards achieving his/her own development goals. The purpose is to continually monitor and track the progress of a ratee. In at least one embodiment, the user who is a validator, supervisor, or designated monitor is prompted first to rate the extent to which each development goal has been achieved during the prior evaluation period, which can be modified in the module, and offer any observational comments. Then, the module automatically requests the ratee to do the same, enabling both the ratee and validator or monitor to compare perspectives on progress towards achieving development goals.

Step 110 for completing at least one training module by each ratee involves transmitting or otherwise making available training module(s) to a ratee. The training module(s), in at least one embodiment, may be based on development goals set by the ratee in step 109. The training module(s) may be automatically selected based on identified areas needing improvement determined by statistically outlying scores and/or frequency of comment word-themes derived from the completed surveys from the ratee's raters. As such, the system of the present invention may comprise a repository of training modules including lessons, training videos, text, quizzes and exams, educational programming, or otherwise appropriate pedagogical tools. The training modules may be made available to a ratee through a web-based platform such as an interactive website or a mobile application. A ratee's progress in a training module may be tracked. Completion or certification status may be transmitted to the ratee, a validator, the ratee's supervisor, human resources personnel, or other designated persons associated with the ratee.

Step 111 for transmitting follow-up surveys to the raters of each ratee involves assessing the extent to which the ratee has improved. The follow-up surveys may be transmitted upon the completion of the at least one training module of 110, transmitted automatically based on predesignated intervals, and/or may be transmitted upon the request of the ratee, validator, facility liaison, or other designated persons. Accordingly, the same or a substantially similar survey may be again transmitted to a ratee's raters, as in step 104. In some embodiments, a brief improvement survey focuses on the extent to which the ratee has shown improvement. In other embodiments, the survey will be the same or substantially similar to ratee's development goals. Similarly, a same or substantially similar report may be generated as in 106. This will allow for the assessment of whether the ratee has improved upon any areas and/or has met the development goals set as in step 109. Of course, the survey may comprise additional questions or metrics that focus on the ratee's behaviors which have been more helpful and effective since the prior survey, and provides follow-up survey feedback to the ratee to reinforce improvement and provide feedback on remaining areas that need improvement.

Any of the above steps may be completed in sequential order in at least one embodiment, though they may be completed in any other order. In at least one embodiment, the above steps may be exclusively performed, but in other embodiments, one or more steps of the steps as described may be skipped.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A method, for assessing and improving communication, teamwork and the quality of healthcare provided by physicians and other healthcare professionals in the workplace, on a computer server in communication with a computer-readable medium having instructions stored thereon which when executed, cause the computer server to perform operations comprising:
(a) instantiating a database on the computer server with user information of each of a plurality of users;
(b) creating a rating scheme from the database comprising a plurality of ratees and raters, wherein each ratee is to be rated by at least one rater;
(c) transmitting surveys from the computer server for assessment of a user in the workplace, including:
transmitting a survey to each to the plurality of raters of each ratee;
wherein the surveys comprises behaviorally-anchored feedback requiring the input of numerical scores.
(d) receiving the completed surveys, including:
receiving a completed survey from at least one of the plurality of raters for each ratee;
receiving a completed self-survey from each ratee;
(e) generating a report for each ratee after a pre-selected time interval based on the completed surveys for each ratee, including:
performing anonymity editing operations designed to help de-identify raters;
filtering and flagging inappropriate comments;
(f) approving the generated reports on the computer server, including:
flagging any identity information from the completed surveys in order to help preserve rater anonymity;
flagging any inappropriate comments from the completed surveys;
performing redaction of the flagged identity information and inappropriate comments by the computer server;
transmitting the approved reports to at least one designated receiving user.

2. The method as recited in claim 1 wherein the instantiating a database of step (a) comprises:
transmitting a link to the plurality of users, the link configured to direct the plurality of users to an input interface for receiving the user input of user information related to the plurality of users,
receiving the user information related to the plurality of users at the computer server,
storing the user information on at least one database in communication with the computer server.

3. The method as recited in claim 1 wherein the creating a rating scheme of step (b) comprises:
designating at least one user as a ratee,
designating for each ratee, at least one rater, wherein said rater is selected by the ratee from the plurality of users.

4. The method as recited in claim 1 wherein the creating a rating scheme of step (b) further comprises:
validating, on the computer, the rating scheme by the at least one validator;

5. The method as recited in claim 4 wherein the validating the rating scheme comprises approving, for at least one ratee, at least one rater selected by the ratee from the plurality of users.

6. The method as recited in claim 5 wherein the validating the rating scheme further comprises the option of adding, for at least one ratee, at least one additional rater selected by the validator from the plurality of users.

7. The method as recited in claim 5 wherein the validating the rating scheme further comprises removing, for at least one ratee, at least one rater selected by the ratee from the plurality of users.

8. The method as recited in claim 1 wherein the creating a rating scheme of step (b) comprises:
designating at least one user as a rater,
designating for each rater, at least one ratee, wherein said ratee is selected by the rater from the plurality of users.

9. The method as recited in claim 1 wherein the creating a rating scheme of step (b) comprises selecting, by at least one user, ratees or raters from the plurality of users.

10. The method as recited in claim 1 wherein the transmitting surveys step (c) further comprises sending reminders at a predetermined interval to each of the raters until a completed survey is received or until the deadline date is reached, whichever comes first.

11. The method as recited in claim 1 wherein the behaviorally-anchored feedback of step (c) comprises a list of predetermined motivating behaviors to be scored by the rater.

12. The method as recited in claim 11 wherein the behaviorally anchored feedback of step (c) further comprises a list of predetermined discouraging behaviors to be scored by the rater.

13. The method as recited in claim 1 wherein the generating of a report in step (e) comprises comparing for each ratee, each ratee's completed self-survey with the completed surveys of the plurality of raters who rated each ratee.

14. The method as recited in claim 1 wherein generating of a report in step (e) comprises identifying word-themes from the completed surveys and presenting clusters of comments, organized by word-themes, to the ratee.

15. The method as recited in claim 14 wherein the word-themes are organized in descending order of frequency.

16. The method as recited in claim 1 further comprising:
(g) providing debriefing to each ratee, including:
identifying strengths and improvement opportunities of the ratee;
creating development goals for each ratee based the feedback received from each ratee's plurality of raters;
(h) transmitting follow-up surveys to the raters for each ratee.

17. The method as recited in claim 16 wherein the development goals comprise completing at least one training module by a ratee, based on the average of behaviorally-anchored numerical scores for that rate.

18. The method as recited in claim 16 wherein the development goals comprise completing at least one training module by a rate, based on the frequency of occurrence of predesignated word-themes.

19. A computer system for assessing and improving the teamwork and quality of care provided by physicians and other healthcare professionals in the workplace, comprising:
(a) a setup component for instantiating a database with user information of each of a plurality of users, wherein the plurality of users may comprise at least one validator;
(b) a rating component for creating a rating scheme from the database comprising a plurality of ratees and raters, wherein each ratee is to be rated by at least one rater;
(c) a validation component for validating the rating scheme on the computer system by the at least one validator;
(d) a survey transmission component for transmitting surveys for assessment of a user in the workplace, including:
transmitting a survey to each to the plurality of raters of each ratee;
transmitting a survey to each ratee;
wherein the surveys comprises behaviorally-anchored feedback.
(e) a survey reception component for receiving the completed surveys, including:
receiving a completed survey from each of the plurality of raters for each ratee;
receiving a completed self-survey from each ratee;
(f) a report generation component for generating a report for each ratee after a predetermined time interval based on the completed surveys for each ratee, including:
performing anonymity editing operations designed to help de-identify raters;
flagging and designating that inappropriate comment(s) have been deleted;
(g) a report approval component for approving the generated reports by the validator, including:
submitting the pre-approved version of the report to validator to provide the validator with the option to approve affirmatively, to approve by default, and/or to flag for removal any overly-identifying information from the completed surveys in order to preserve anonymity and/or to flag as inappropriate comments deleted those comments for which the validator determines has no constructive merit;
(h) a report transmission component for transmitting the approved reports to at least one designated receiving user.

20. A computer program on a non-transitory computer readable medium, for execution by a computer for assessing and improving the quality of care provided by physicians and other healthcare professionals in the workplace, the computer program comprising:
(a) a code segment for instantiating a database with user information of each of a plurality of users, wherein the plurality of users may comprise at least one validator;
(b) a code segment for creating a rating scheme from the database comprising a plurality of ratees and raters, wherein each ratee is to be rated by at least one rater;
(c) a code segment for validating the rating scheme on the computer by the at least one validator;
(d) a code segment for transmitting surveys for assessment of a user in the workplace, including:
transmitting a survey to each to the plurality of raters of each ratee;
transmitting a survey to each ratee;
wherein the surveys comprises behaviorally-anchored feedback.
(e) a code segment for receiving the completed surveys, including:
receiving a completed survey from each of the plurality of raters for each ratee;
receiving a completed self-survey from each ratee;
(f) a code segment for generating a report for each ratee after a predetermined time interval based on the completed surveys for each ratee, including:
performing anonymity editing operations designed to help de-identify raters;
flagging and indicating that inappropriate comments have been deleted;
(g) a code segment for approving the generated reports by the validator, including:
identifying any overly-identifying information from the completed surveys and requesting that they be redacted in order to preserve anonymity;
requesting that any inappropriate comments with no constructive merit be redacted or identified as inappropriate comment deleted;
(h) a code segment for transmitting the approved reports to at least one designated receiving user.
